(19) United States
(12) Patent Application Publication
(10) Pub. No.: US 2024/0380491 A1
(43) Pub. Date: Nov. 14, 2024

(54) Optical Transmission System, Optical Transmission Method, Transmitter, and Receiver

(71) Applicant: Nippon Telegraph and Telephone Corporation, Tokyo (JP)

(72) Inventor: Nikolaos-Panteleimon Diamantopoulos, Musashino-shi, Tokyo (JP)

(21) Appl. No.: 18/692,205

(22) PCT Filed: Oct. 22, 2021
(86) PCT No.: PCT/JP2021/039059

§ 371 Date: Mar. 14, 2024

(51) Int. Cl. H04B 10/50; H04B 10/54; H04L 25/03

(52) U.S. Cl. CPC H04B 10/504; H04B 10/541; H04L 25/03343; H04B 2210/254; H04L 2025/03426

(57) ABSTRACT

An optical transmission system includes N directly-modulated lasers configured to convert N-channel first electrical modulated signals into N-channel optical modulated signals and transmit the N-channel optical modulated signals, N photodetectors configured to receive the N-channel optical modulated signals and convert the N-channel optical modulated signals into N-channel second electrical modulated signals, and at least one of a first MIMO equalizer configured to execute equalization processing for the N-channel first electrical modulated signals, thereby compensating for crosstalk between the N-channel first electrical modulated signals, and a second MIMO equalizer configured to execute equalization processing for the N-channel second electrical modulated signals, thereby compensating for crosstalk between the N-channel second electrical modulated signals, wherein a matrix coefficient based on an impulse response is used in the equalization processing. Hence, the present invention can provide an optical transmission system capable of reducing crosstalk and obtaining a satisfactory BER characteristic.

### TECHNICAL FIELD

The present invention relates to an optical transmission system using a directly-modulated laser, an optical transmission method, a transmitter, and a receiver.

### BACKGROUND ART

It is predicted that Internet traffic in data centers and access networks will increase, and an Ethernet (registered trademark) with a data rate of 800-Gb/s or 1.6 Tb/s is expected to be put into practical use. In short distance communication, an intensity-modulated direct-detected (IMDD) system has received attention from the viewpoint of cost reduction and power consumption reduction.

An optical transceiver used in the IMDD system includes a directly-modulated laser (DML) of low power consumption, and copes with a plurality of wavelength channels in wavelength division multiplexing (WDM) or a plurality of spatial channels in a space division multiplexing (SDM) system. The optical transceiver that copes with WDM/SDM uses a photonic integrated circuits/chip (PIC), and components such as a laser, a modulator, and a photodetector are implemented in the same PIC.

Additionally, a modulation format in recent standardization techniques is 4-level pulse-amplitude modulation (PAM). To implement WDM/SDM with 800-Gb/s or 1.6 Tb/s, each of 8 or 16 channels needs to have a modulation rage of 50 GBaud or more.

### CITATION LIST

### Patent Literature

PTL 1: WO 2020/105430

### Non Patent Literature

NPL 1: N. P. Diamantopoulos, et al., “400-Gb/s DMT-SDM Transmission based on Membrane DML-Array-on-Silicon”, J. Lightw. Technol., vol. 37, no. 8, pp. 1805-1812 April 2019.
NPL 2: N. P. Diamantopoulos, et al., “4×56-GBaud PAM-4 SDM Transmission Over 5.9-km 125-micrometer-Cladding MCF Using III-V-on-Si DMLs”, in Proc. Optical Fiber Communications Conference and Exhibition (OFC 2020), San Diego, CA, USA, 8-12 Mar. 2020, paper W1D.4.
NPL 3: T. Fujii, et al., “Multiwavelength membrane laser array using selective area growth on directly bonded InP on SiO2/Si”, Optica, vol. 7, no. 7, pp. 838-846, July 2020.

### SUMMARY OF INVENTION

### Technical Problem

When implementing the plurality of components in the PIC, an increase in crosstalk poses a problem. Concerning crosstalk, resistance to direct current crosstalk can relatively easily be obtained. On the other hand, high-frequency crosstalk greatly in-fluences the signal-to-interference and noise ratio (SINR) of the PAM-4 modulation. The influence is important at a higher data rate because the band limitation of electronic and optoelectronic components degrades the PAM-4 characteristic.

FIGS. 7A to 7D show 54-GBaud PAM-4 modulation by low power consumption membrane DMLs on Si in an IMDD system (Non-Patent Literatures 1 to 3). FIGS. 7A and 7B show eye diagrams of directly-modulated signals without any electrical RF crosstalk and with an electrical RF crosstalk of −15 dB. The directly-modulated signals were generated by a membrane laser on Si using a current of 13 mA.

According to measurement using a conventional DML-based PIC, RF crosstalk is about −15 dB (Non-Patent Literatures 1 and 2). As is apparent from the simulation results of the eye diagrams shown in FIGS. 7A and 7B, if the RF crosstalk is −15 dB, the PAM-4 characteristic very largely degrades as compared to a case in which the RF crosstalk is not assumed.

In the conventional standardization of Ethernet, a bit-error rate (BER) required of FEC (Forward Error Correction) is about 2.2E-4 or less, and a feed-forward equalizer (FFE) is also used.

FIG. 7C shows a BER with respect to the number of equalizer taps without any electrical RF crosstalk. When the number of equalizer taps is 4 or more, the BER decreases to about 1e-6. As described above, in the DML system, the optimum number of FFE taps is 4.

Even if four FFE taps are used, if the RF crosstalk is −15 dB, the BER degrades to about 1.3E-2, and the BER (2.2E-4) of the FFE threshold cannot be achieved, as shown in FIG. 7B.

FIG. 7D shows the dependence of the BER on electrical RF crosstalk when 4 taps are used. When the RF crosstalk changes from −40 dB to −10 dB, the BER degrades. When the RF crosstalk is −22 dB or more, the BER is 1.0E-4 or more.

As described above, when the RF crosstalk increases, the BER and the PAM-4 characteristic degrade, resulting in a problem.

### Solution to Problem

In order to solve the above-described problem, according to the present invention, there is provided an optical transmission system comprising N directly-modulated lasers configured to convert N-channel first electrical modulated signals into N-channel optical modulated signals and transmit the N-channel optical modulated signals, N photodetectors configured to receive the N-channel optical modulated signals and convert the N-channel optical modulated signals into N-channel second electrical modulated signals, and at least one of a first MIMO equalizer configured to execute equalization processing for the N-channel first electrical modulated signals, thereby compensating for crosstalk between the N-channel first electrical modulated signals, and a second MIMO equalizer configured to execute equalization processing for the N-channel second electrical modulated signals, thereby compensating for crosstalk between the N-channel second electrical modulated signals, characterized in that a matrix coefficient based on an impulse response is used in the equalization processing.

According to the present invention, there is also provided an optical transmission method using N directly-modulated lasers configured to convert N-channel first electrical modulated signals into N-channel optical modulated signals and transmit the N-channel optical modulated signals, N photodetectors configured to receive the N-channel optical modulated signals and convert the N-channel optical modulated signals into N-channel second electrical modulated signals, and at least one of a first MIMO equalizer to which the N-channel first electrical modulated signals are input and a second MIMO equalizer to which the N-channel second electrical modulated signals are input, the method comprising the steps of setting an arbitrary matrix coefficient in at least one of the first MIMO equalizer and the second MIMO equalizer, inputting at least one of the group of the N-channel first electrical modulated signals and the group of the N-channel second electrical modulated signals to at least one of the first MIMO equalizer and the second MIMO equalizer and experimentally measuring N-channel output signals, deciding an optimum matrix coefficient such that a means squared error between the measured output signal and a desired output signal is minimized in each channel in equation (A), and executing, by at least one of the first MIMO equalizer and the second MIMO equalizer, equalization processing using the optimum matrix coefficient for at least one of the group of the N-channel first electrical modulated signals and the group of the N-channel second electrical modulated signals, thereby compensating for crosstalk between signals in at least one of the group of the N-channel first electrical modulated signals and the group of the N-channel second electrical modulated signals.

According to the present invention, there is also provided an optical transmission method using N directly-modulated lasers configured to convert N-channel first electrical modulated signals into N-channel optical modulated signals and transmit the N-channel optical modulated signals, N photodetectors configured to receive the N-channel optical modulated signals and convert the N-channel optical modulated signals into N-channel second electrical modulated signals, and at least one of a first MIMO equalizer to which the N-channel first electrical modulated signals are input and a second MIMO equalizer to which the N-channel second electrical modulated signals are input, the method comprising the steps of calculating a vector of the N-channel optical modulated signals by equation (B), calculating a vector of an output signal of at least one of the first MIMO equalizer and the second MIMO equalizer by equation (A), deciding an optimum matrix coefficient such that a means squared error between the calculated vector of the output signal and a desired output signal vector is minimized, and executing, by at least one of the first MIMO equalizer and the second MIMO equalizer, equalization processing using the optimum matrix coefficient for at least one of the group of the N-channel first electrical modulated signals and the group of the N-channel second electrical modulated signals, thereby compensating for crosstalk between signals in at least one of the group of the N-channel first electrical modulated signals and the group of the N-channel second electrical modulated signals.

$$\begin{matrix}[ Math . 1 ] & \\ Y = WX & ( A )\end{matrix}$$

where X is a vector of one of the group of the N-channel first electrical modulated signals and the group of the N-channel second electrical modulated signals, Y is a vector of the signals that have undergone the equalization processing, and W is the matrix coefficient W.

$$\frac{d N ( t )}{d t} = {η}_{i} \frac{I ( t ) + {I}_{XT} ( T )}{q V} - R ( N ( t ) ) - G ( t ) S ( t ) \qquad ( B )$$

where t is time, N is a carrier density of a DML, ηᵢ is a quantum efficiency, q is a charge density, and V is a volume of an active layer of the DML. Also, I and I_{XT} are instantaneous currents of an applied signal and crosstalk, respectively. R(N) is a carrier recombination factor, G is a gain, and S is a photon density.

According to the present invention, there is provided a transmitter configured to, in an optical transmission system sequentially including the transmitter, a communication channel, and a receiver, transmit N-channel analog optical modulated signals to be received by the receiver via the communication channel, characterized by comprising a MIMO equalizer to which N-channel digital electrical modulated signals are input, a DA converter configured to convert the N-channel digital electrical modulated signals into N-channel analog electrical modulated signals, N RF drivers to which the N-channel analog electrical modulated signals are input, and N directly-modulated lasers configured to be driven by the N-channel analog electrical modulated signals input to the N RF drivers and output the N-channel analog optical modulated signals, wherein the MIMO equalizer executes equalization processing using a matrix coefficient based on an impulse response for the N-channel digital electrical modulated signals, thereby compensating for crosstalk between the N-channel electrical modulated signals.

According to the present invention, there is provided a receiver configured to, in an optical transmission system sequentially including a transmitter, a communication channel, and the receiver, receive N-channel analog optical modulated signals transmitted from the transmitter via the communication channel, characterized by comprising a photodetector array including N photodetectors configured to receive N-channel analog optical modulated signals and convert the N-channel analog optical modulated signals into N-channel analog electrical modulated signals, an AD converter configured to convert the N-channel analog electrical modulated signals into an N-channel digital electrical modulated signals, and a MIMO equalizer to which the N-channel digital electrical modulated signals are input, wherein the MIMO equalizer executes equalization processing using a matrix coefficient based on an impulse response for the N-channel digital electrical modulated signals, thereby compensating for crosstalk between the N-channel electrical modulated signals.

### Advantageous Effects of Invention

According to the present invention, it is possible to provide an optical transmission system, an optical transmission method, a transmitter, and a receiver, which can reduce crosstalk and obtain a satisfactory BER characteristic.

### BRIEF DESCRIPTION OF DRAWINGS

FIG. 1 is a block diagram showing the configuration of an optical transmission system according to the first embodiment of the present invention;

FIG. 2 is a view for explaining the effect of the optical transmission system according to the first embodiment of the present invention;

FIG. 3A is a view for explaining the effect of the optical transmission system according to the first embodiment of the present invention;

FIG. 3B is a view for explaining the effect of the optical transmission system according to the first embodiment of the present invention;

FIG. 3C is a view for explaining the effect of the optical transmission system according to the first embodiment of the present invention;

FIG. 4 is a block diagram showing the configuration of an optical transmission system according to Modification 1 of the first embodiment of the present invention;

FIG. 5 is a block diagram showing the configuration of an optical transmission system according to Modification 2 of the first embodiment of the present invention;

FIG. 6 is a block diagram showing the configuration of an optical transmission system according to Modification 3 of the first embodiment of the present invention;

FIG. 7A is a view for explaining the operation of a conventional optical transmission system;

FIG. 7B is a view for explaining the operation of the conventional optical transmission system;

FIG. 7C is a view for explaining the operation of the conventional optical transmission system; and

FIG. 7D is a view for explaining the operation of the conventional optical transmission system.

### DESCRIPTION OF EMBODIMENTS

### First Embodiment

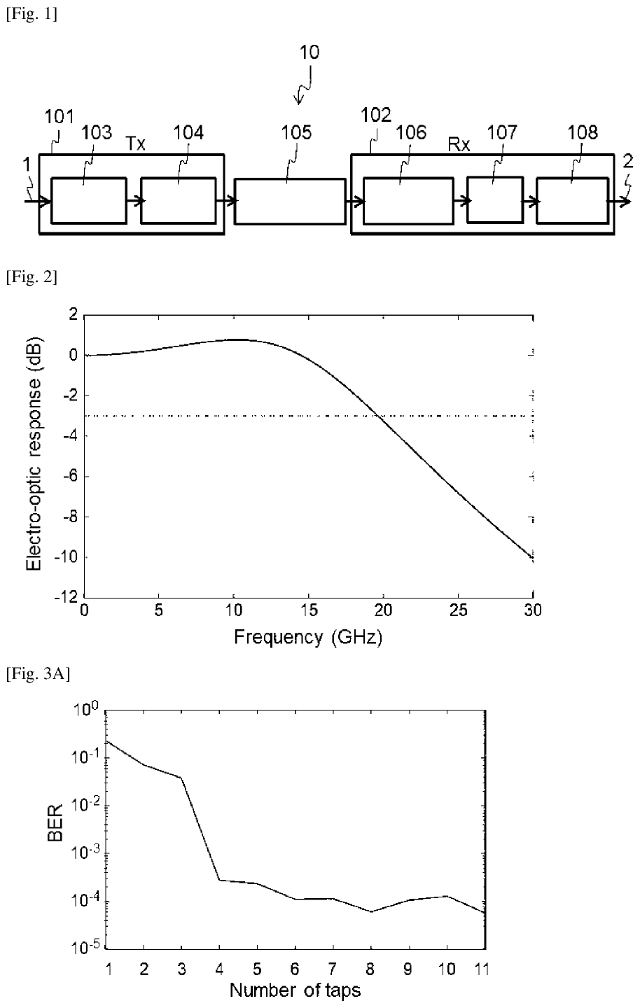

An optical transmission system, an optical transmission method, a transmitter, and a receiver according to the first embodiment of the present invention will be described with reference to FIGS. 1 to 3C.

### (Configuration of Optical Transmission System)

As shown in FIG. 1, an optical transmission system 10 according to this embodiment includes a directly-modulated laser (DML)-based transmitter (Tx) 101, a direct-detection-based receiver (Rx) 102, and a communication channel 105 that connects the transmitter 101 and the receiver 102. In the optical transmission system 10, an analog electrical modulated signal 1_1 is input to the transmitter 101, and a digital electrical modulated signal 2_1 is output from the receiver 102.

The transmitter 101 includes a driving device 103 and a laser array 104 sequentially from the input side. The driving device 103 includes a plurality of (N) RF drivers. The laser array 104 includes a plurality of (N) DMLs. An RF driver drives a DML by an RF electrical signal. In the DML, output light is directly modulated by the RF signal, and an electrical modulated signal is converted into an optical modulated signal.

The communication channel 105 is an optical fiber, a free space such as air, or an optical waveguide in a PIC.

The receiver 102 includes a photodetector (PD) array 106, an AD (Analog-to-Digital) converter 107, and a MIMO (Multiple Input, Multiple Output) equalizer 108 sequentially from the side connected to the communication channel 105.

The PD array 106 includes a plurality of (N) PDs, and converts an analog optical modulated signal into an analog electrical modulated signal.

The AD converter 107 includes a plurality of (N) AD converters, and converts an analog electrical modulated signal into a digital electrical modulated signal.

The MIMO equalizer 108 is a characteristic component in the optical transmission system 10, and is used to compensate for RF crosstalk caused by adjacent channels in each of the laser array 104, the PD array 106, and the driving device 103.

In the optical transmission system 10, the N DMLs of the laser array 104 are directly modulated by the analog electrical modulated signals of N channels, which are input to the N RF drivers of the driving device 103 in the transmitter 101. Analog modulated signals of N channels are transmitted from the laser array 104, propagate through the communication channel 105, and are received by the N PDs of the PD array 106 in the receiver 102. The analog optical modulated signals of N channels received by the PD array 106 are converted into analog electrical modulated signals of N channels and converted into digital electrical modulated signals by the N AD converters 107. The digital electrical modulated signals of N channels are input to the MIMO equalizer 108, subjected to equalization processing, and output.

Here, the MIMO equalizer 108 compensate for RF crosstalk generated between the modulated signals of N channels.

Also, if the plurality of (N-channel) signals are 4 channels, the DML, the PD, the RF driver, and the AD converter 107 each include four components. For 8-channel signals, 8 components are included. For 16-channel signals, 16 components are included.

### (Operation of MIMO Equalizer)

The operation of the MIMO equalizer 108 in the optical transmission system 10 according to this embodiment will be described below.

When an input RF signal in the MIMO equalizer 108 is defined as a vector X, and an output RF signal is defined as a vector Y, the relationship between these is given by

$$\begin{matrix}[ Math . 2 ] & \\ Y = WX & ( 1 )\end{matrix}$$

where W is the weight matrix of the MIMO equalizer 108, which is the reciprocal of the impulse response of the MIMO equalizer 108 in the DML transmission system.

In the MIMO equalizer 108, the number of channels and the number of taps of each channel are assumed to be N_{ch} and Nₜₐₚₛ, respectively.

When the vector of the input signal is represented by X∈R^{Nch*Ntaps×1}, and the vector of the output signal is represented by Y∈R^{Nch×1}, W∈R^{Nch×Nch*Ntaps} holds.

The matrix coefficient (weight) W is trained such that the means squared error (MSE) between Y and a known target signal is minimized.

In this training, training is performed using a measured value experimentally acquired by a Back-to-back optical system. Here, Back-to-back is a configuration for experiments, which directly connects the transmitter 101 and the receiver 102 without a transmission channel.

For example, N-channel signals X₁ including experimentally obtained crosstalk are input to the MIMO equalizer 108 in which the matrix coefficient (weight) W is set to W₁, and N-channel output signals Y₁ of the MIMO equalizer 108 are measured. An optimum matrix coefficient Wₒₚₜ is decided such that the MSE between each of the measured N-channel output signals Y₁ and a desired output signal (that is, an output signal in which the influence of crosstalk is suppressed) Y₀ is minimized in each channel.

When the optimum matrix coefficient Wₒₚₜ is set in the MIMO equalizer 108, a signal similar to the desired output signal Y₀, that is, a signal in which the influence of crosstalk is suppressed is output.

As described above, the MIMO equalizer 108 in the optical transmission system 10 according to this embodiment executes equalization processing using the matrix coefficient based on the impulse response, thereby compensating for crosstalk between the plurality of (N-channel) signals.

### Effect

To demonstrate the effect of the optical transmission system 10 according to this embodiment, a simulation was conducted based on the DML-based transmitter 101. In the simulation, a typical electro-optic (EO) response of the DML shown in FIG. 2 was assumed. The DML is a membrane laser on Si, and operates at a bias current of 13 mA in a bandwidth of −3 dB at 20 GHz.

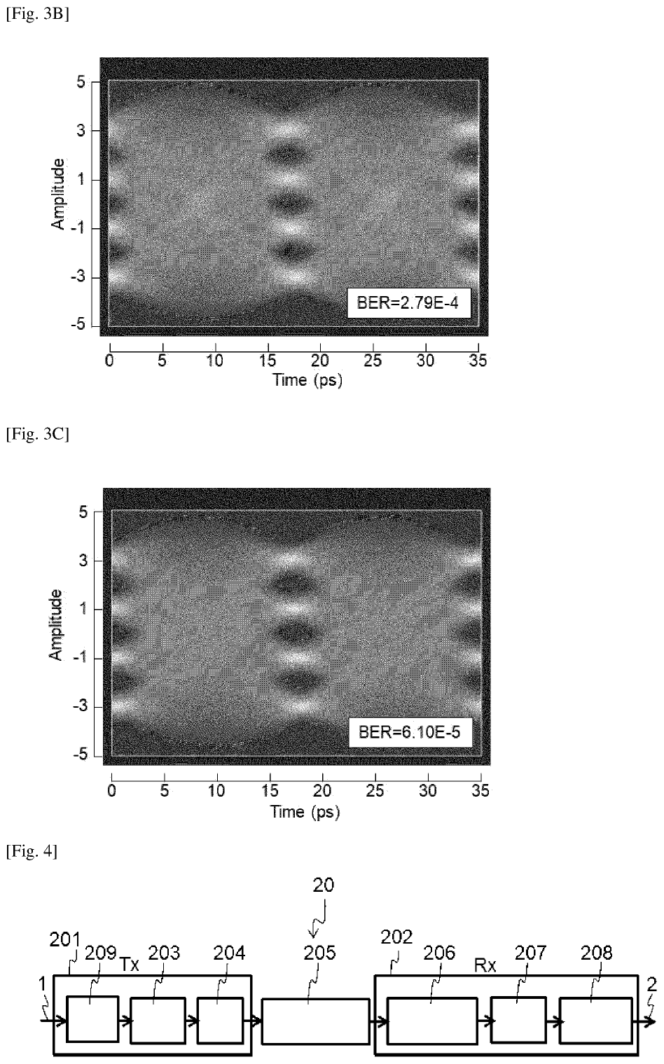

FIG. 3A shows the simulation result of the BER characteristic of a 54-Gbaud PAM-4 signal with respect to the number Nₜₐₚₛ of taps of the MIMO equalizer. Here, RF crosstalk is −15 dB.

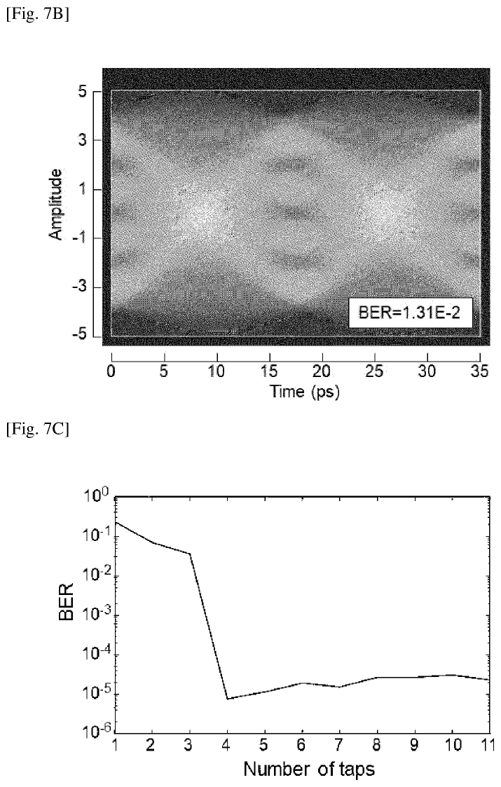

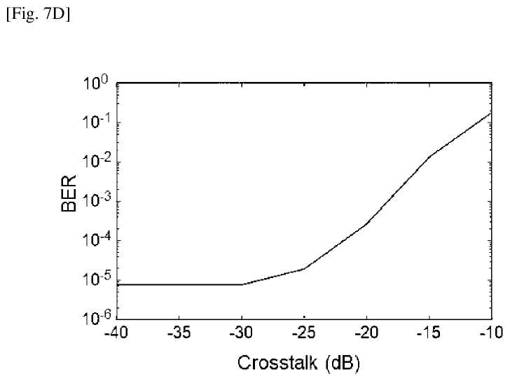

The BER decreases along with an increase in the number of taps. When the number of taps is 1 to 3, the BER is about 2e-1 to 4e-2, which is a value similar to that in the above-described case in which crosstalk is absent (FIG. 7C). In the optical transmission system 10, crosstalk is reduced in this way.

Also, when the number of taps increases to 4, the BER remarkably decreases. The BER decreases to about 3e-4 for 4 taps, and decreases to about 1e-4 or less for 8 taps. In this way, a satisfactory BER characteristic can be obtained in the optical transmission system 10.

FIGS. 3B and 3C show the eye diagrams of a 54-Gbaud PAM-4 signal in a case which the number Nₜₐₚₛ of taps is 4 and in a case in which the number Nₜₐₚₛ of taps is 8, respectively.

If the number Nₜₐₚₛ of taps is 4, a satisfactory eye diagram can be obtained as compared to a case in which crosstalk exists (FIG. 7B). If the number Nₜₐₚₛ of taps is 8, the BER is 6.1E-5 and is reduced to a value equal to or less than the FEC threshold of an Ethernet link.

As described above, in the optical transmission system 10, by the MIMO equalizer having at least one tap, crosstalk can be reduced, and a satisfactory BER characteristic can be obtained. In addition, the number of taps of the MIMO equalizer is preferably 4 or more, and this can remarkably reduce crosstalk and obtain a satisfactory BER characteristic.

According to the optical transmission system, the optical transmission method, the transmitter, and the receiver of this embodiment, it is possible to reduce crosstalk by the MIMO equalizer and obtain a satisfactory BER characteristic.

Hence, in short distance communication up to about 2 km, a signal of 400 Gb/s or more can reliably be transmitted by low power consumption.

In particular, when the transmitter and the receiver in the optical transmission system according to this embodiment are mounted on a photonic integrated circuit or a chip (PIC), a signal of 400 Gb/s or more can reliably be transmitted by low power consumption in short distance communication. Here, one of the transmitter and the receiver may be mounted on a PIC.

### Modification 1

An optical transmission system, an optical transmission method, a transmitter, and a receiver according to Modification 1 of the first embodiment of the present invention will be described with reference to FIG. 4.

As shown in FIG. 4, an optical transmission system 20 according to Modification 1 includes a DML-based transmitter (Tx), a direct-detection-based receiver (Rx), and a communication channel 205 that connects a transmitter 201 and a receiver 202. In the optical transmission system 20, a digital electrical modulated signal is input to the transmitter 201, and a digital electrical modulated signal is output from the receiver 202.

The transmitter 201 includes a DA (Digital-to-Analog) converter, an RF driver, and a laser array 204 sequentially from the input side. The receiver 202 includes a PD array 206, an AD converter 207, and a MIMO equalizer 208 sequentially from the side connected to the communication channel 205. The remaining components are the same as in the first embodiment.

In the optical transmission system 20, N-channel digital electrical modulated signals input to N DA converters 209 in the transmitter 201 are converted into N-channel analog electrical modulated signals and input to the N RF drivers. After that, N-channel analog optical modulated signals are transmitted from the laser array 204 and propagate through the communication channel 205, as in the first embodiment. Next, the signals are received by the PD array 206 in the receiver 202, converted into N-channel analog electrical modulated signals, and subjected to equalization processing by the MIMO equalizer 208, and then, digital electrical modulated signals are output. Here, the MIMO equalizer 208 compensates for RF crosstalk generated between the N-channel modulated signals.

According to the optical transmission system, the optical transmission method, the transmitter, and the receiver of this modification, it is possible to reduce crosstalk by the MIMO equalizer and obtain a satisfactory BER characteristic, as in the first embodiment.

### Modification 2

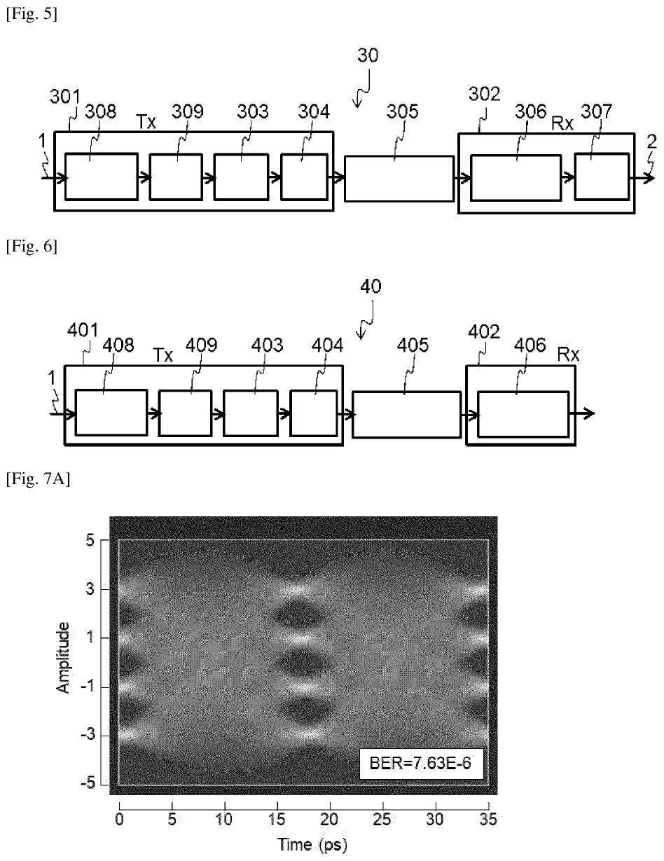

An optical transmission system, an optical transmission method, a transmitter, and a receiver according to Modification 2 of the first embodiment of the present invention will be described with reference to FIG. 5.

As shown in FIG. 5, an optical transmission system 30 according to Modification 2 of this embodiment includes a DML-based transmitter (Tx), a direct-detection-based receiver (Rx), and a communication channel 305 that connects a transmitter 301 and a receiver 302. In the optical transmission system 30, a digital electrical modulated signal is input to the transmitter 301, and a digital electrical modulated signal is output from the receiver 302.

The transmitter 301 includes a MIMO equalizer 308, a DA converter 309, an RF driver, and a laser array 304 sequentially from the input side. The receiver 302 includes a PD array 306 and an AD converter 307 sequentially from the side connected to the communication channel 305. The remaining components are the same as in the first embodiment.

In the optical transmission system 30, N-channel digital electrical modulated signals input to the MIMO equalizer 308 in the transmitter 301 are subjected to equalization processing and input to the N DA converters 309. Next, the signals are converted into N-channel analog electrical modulated signals by the N DA converters 309 and input to the N RF drivers. The N-channel analog optical modulated signals are transmitted from the laser array 304 driven by the N RF drivers and propagate through the communication channel 305. The signals are then received by the PD array 306 in the receiver 302, converted into N-channel digital electrical modulated signals by the AD converter 307, and output. Here, the MIMO equalizer 308 compensates for RF crosstalk generated between the N-channel modulated signals.

According to the optical transmission system, the optical transmission method, the transmitter, and the receiver of this modification, it is possible to reduce crosstalk by the MIMO equalizer and obtain a satisfactory BER characteristic, as in the first embodiment.

### Modification 3

An optical transmission system, an optical transmission method, a transmitter, and a receiver according to Modification 3 of the first embodiment of the present invention will be described with reference to FIG. 6.

As shown in FIG. 6, an optical transmission system 40 according to Modification 3 of this embodiment includes a DML-based transmitter (Tx), a direct-detection-based receiver (Rx), and a communication channel 405 that connects a transmitter 401 and a receiver 402. In the optical transmission system 40, a digital electrical modulated signal is input to the transmitter 401, and an analog electrical modulated signal is output from the receiver 402.

The transmitter 401 includes a MIMO equalizer 408, a DA converter 409, an RF driver, and a laser array 404 sequentially from the input side. The receiver 402 includes a PD array 406. This modification is different from Modification 2 in that an AD converter is not provided in the stage next to the PD array 406 in the receiver 402, and the output is an analog electrical modulated signal. The remaining components and operations are the same as in Modification 2.

According to the optical transmission system, the optical transmission method, the transmitter, and the receiver of this modification, it is possible to reduce crosstalk by the MIMO equalizer and obtain a satisfactory BER characteristic, as in the first embodiment.

As described above, each of the optical transmission systems according to the embodiment and the modifications thereof includes N directly-modulated lasers, N photodetectors, and a MIMO equalizer. Here, the N directly-modulated lasers convert N-channel electrical modulated signals (first electrical modulated signals) into N-channel optical modulated signals and transmit these. The N photodetectors receive the N-channel optical modulated signals and convert these into N-channel electrical modulated output signals (second electrical modulated signals). The MIMO equalizer executes equalization processing using a matrix coefficient based on an impulse response for one of the group of the N-channel first electrical modulated signals and the group of the N-channel second electrical modulated signals. This compensates for crosstalk between signals in one of the group of the N-channel first electrical modulated signals and the group of the N-channel second electrical modulated signals.

### Second Embodiment

An optical transmission system, an optical transmission method, a transmitter, and a receiver according to the second embodiment of the present invention will be described.

### (Configuration of Optical Transmission System)

As shown in FIG. 1, an optical transmission system according to this embodiment includes a DML-based transmitter (Tx), a direct-detection-based receiver (Rx), and a communication channel that connects the Tx and the Rx. This configuration is the same as in the first embodiment.

### (Operation of MIMO Equalizer)

As in the first embodiment, the MIMO equalizer in the optical transmission system according to this embodiment outputs an RF signal of a vector Y when an RF signal of a vector X is input, as indicated by equation (1). The coefficient of a matrix W is trained based on a training algorithm by minimizing the MSE between Y and a known target signal.

In this embodiment, a simulation including RF crosstalk is used in the training.

In this simulation, first, the output of the DML including crosstalk is calculated as N-channel signal vectors X₁.

Here, the output of the DML is simulated in consideration of crosstalk between adjacent lasers via a leakage bias current from one channel to an adjacent channel. In this numerical simulation, a rate equation of a carrier density represented by equation (2) is used.

$$\begin{matrix}[ Math . 3 ] & \\ \frac{d N ( t )}{d t} = {η}_{i} \frac{I ( t ) + {I}_{XT} ( T )}{q V} - R ( N ( t ) ) - G ( t ) S ( t ) & ( 2 )\end{matrix}$$

where t is time, N is the carrier density of the DML, ηᵢ is the quantum efficiency, q is the charge density, and V is the volume of the active layer of the DML. Also, I and I_{XT} are the instantaneous currents of an applied signal and crosstalk, respectively. R(N) is the carrier recombination factor, G is the gain, and S is the photon density.

Also, in the calculation of I(t), a 54-Gbaud PAM-4 signal formed by a root-raised cosine RRC) filter with a rolloff coefficient of 0.1 is assumed.

Next, the matrix coefficient W is set to W₁, and using the calculated signal vector X₁, N-channel output signals Y₁ are calculated from equation (1) as the output of the MIMO equalizer.

Finally, an optimum matrix coefficient Wₒₚₜ is decided such that the MSE between each of the calculated signal vector Y₁ and a desired output signal vector (that is, the vector of an output signal in which the influence of crosstalk is suppressed) Y₀ is minimized in each channel.

When the optimum matrix coefficient Wₒₚₜ is set in the MIMO equalizer, a signal similar to the desired output signal Y₀, that is, a signal in which the influence of crosstalk is suppressed is output.

As described above, the MIMO equalizer in the optical transmission system according to this embodiment executes equalization processing using the matrix coefficient based on the impulse response, which is obtained by the simulation.

According to the optical transmission system, the optical transmission method, the transmitter, and the receiver of this embodiment, it is possible to reduce crosstalk by the MIMO equalizer and obtain a satisfactory BER characteristic, as in the first embodiment.

The optical transmission system according to this embodiment uses the same configuration as in the first embodiment. However, the same configuration as in one of Modifications 1 to 3 of the first embodiment may be used.

As described above, the optical transmission system according to this embodiment includes N directly-modulated lasers, N photodetectors, and a MIMO equalizer. Here, the N directly-modulated lasers convert N-channel electrical modulated signals (first electrical modulated signals) into N-channel optical modulated signals and transmit these. The N photodetectors receive the N-channel optical modulated signals and convert these into N-channel electrical modulated output signals (second electrical modulated signals). The MIMO equalizer executes equalization processing using a matrix coefficient based on an impulse response for one of the group of the N-channel first electrical modulated signals and the group of the N-channel second electrical modulated signals. This compensates for crosstalk between signals in one of the group of the N-channel first electrical modulated signals and the group of the N-channel second electrical modulated signals.

According to the optical transmission system, the optical transmission method, the transmitter, and the receiver of the embodiment of the present invention, it is possible to cope with both a digital signal and an analog signal.

An example in which the optical transmission system, the optical transmission method, the transmitter, and the receiver of the embodiment of the present invention perform training using experimentally acquired measurement values and simulations has been described. However, the present invention is not limited to this, and training may be performed using a known training algorism concerning an equalizer.

An example in which the optical transmission system, the optical transmission method, the transmitter, and the receiver of the embodiment of the present invention include the MIMO equalizer in the transmitter or the receiver, and execute equalization processing for one of a group of the first electrical modulated signals and a group of the second electrical modulated signals has been described. However, the present invention is not limited to this, and the MIMO equalizer may be included in both the transmitter and the receiver, and equalization processing may be executed for both a group of the first electrical modulated signals and a group of the second electrical modulated signals.

According to the embodiment of the present invention, in the configurations of the optical transmission system, the optical transmission method, the transmitter, and the receiver, an example of the structures, dimensions, materials, and the like of the component parts has been described. However, the present invention is not limited to this. Any configuration can be used if it can exhibit the function of the optical transmission system and provide the effect.

### INDUSTRIAL APPLICABILITY

The present invention is related to an optical transmission system, an optical transmission method, a transmitter, and a receiver, and can be applied to short distance communication in a data center or the like.

### REFERENCE SIGNS LIST

10 . . . optical transmission system, 101 . . . transmitter, 102 . . . receiver, 103 . . . driving device, 104 . . . laser array, 105 . . . communication channel, 106 . . . photodetector array, 107 . . . . AD converter, 108 . . . . MIMO equalizer

1. An optical transmission system comprising:
N directly-modulated lasers configured to convert N-channel first electrical modulated signals into N-channel optical modulated signals and transmit the N-channel optical modulated signals;
N photodetectors configured to receive the N-channel optical modulated signals and convert the N-channel optical modulated signals into N-channel second electrical modulated signals; and
at least one of a first MIMO equalizer configured to execute equalization processing for the N-channel first electrical modulated signals, thereby compensating for crosstalk between the N-channel first electrical modulated signals, and a second MIMO equalizer configured to execute equalization processing for the N-channel second electrical modulated signals, thereby compensating for crosstalk between the N-channel second electrical modulated signals, wherein
a matrix coefficient based on an impulse response is used in the equalization processing.

2. The optical transmission system according to claim 1, wherein
in equation (A) expressed by a vector X of at least one of the group of the N-channel first electrical modulated signals and the group of the N-channel second electrical modulated signals, a vector Y of the signals that have undergone the equalization processing, and the matrix coefficient W,
an optimum matrix coefficient is trained such that a means squared error between the vector Y experimentally measured for the vector X and a desired output signal vector is minimized,
$$\begin{matrix}[ Math . 1 ] & \\ Y = WX & ( A )\end{matrix}$$

3. The optical transmission system according to claim 1, wherein
in equation (A) expressed by a vector X of at least one of the group of the N-channel first electrical modulated signals and the group of the N-channel second electrical modulated signals, a vector Y of the signals that have undergone the equalization processing, and the matrix coefficient W,
an optimum matrix coefficient is trained such that a means squared error between the vector Y simulated for the vector X calculated using equation (B) and a desired output signal vector is minimized,
$$\begin{matrix}[ Math . 2 ] & \\ Y = WX & ( A )\end{matrix}$$
$$\begin{matrix}[ Math . 3 ] & \\ \frac{d N ( t )}{d t} = {η}_{i} \frac{I ( t ) + {I}_{XT} ( T )}{q V} - R ( N ( t ) ) - G ( t ) S ( t ) & ( B )\end{matrix}$$
where t is time, N is a carrier density of a DML, ηᵢ is a quantum efficiency, q is a charge density, and V is a volume of an active layer of the DML. Also, I and I_{XT} are instantaneous currents of an applied signal and crosstalk, respectively. R(N) is a carrier recombination factor, G is a gain, and S is a photon density.

4. The optical transmission system according to claim 1, comprising:
a transmitter sequentially comprising
N RF drivers configured to drive the N directly-modulated lasers, and
the N directly-modulated lasers;
a receiver sequentially comprising
the N photodetectors,
N AD converters, and
the MIMO equalizer; and
a communication channel configured to connect the transmitter and the receiver.

5. The optical transmission system according to claim 1, comprising:
a transmitter sequentially comprising
the MIMO equalizer,
N DA converters,
N RF drivers configured to drive the N directly-modulated lasers, and
the N directly-modulated lasers;
a receiver comprising the N photodetectors; and
a communication channel configured to connect the transmitter and the receiver.

6. The optical transmission system according to claim 4, wherein at least one of the transmitter and the receiver is mounted on a PIC.

7. An optical transmission method using:
N directly-modulated lasers configured to convert N-channel first electrical modulated signals into N-channel optical modulated signals and transmit the N-channel optical modulated signals;
N photodetectors configured to receive the N-channel optical modulated signals and convert the N-channel optical modulated signals into N-channel second electrical modulated signals; and
at least one of a first MIMO equalizer to which the N-channel first electrical modulated signals are input and a second MIMO equalizer to which the N-channel second electrical modulated signals are input,
the method comprising the steps of:
setting an arbitrary matrix coefficient in at least one of the first MIMO equalizer and the second MIMO equalizer;
inputting at least one of the group of the N-channel first electrical modulated signals and the group of the N-channel second electrical modulated signals to at least one of the first MIMO equalizer and the second MIMO equalizer and experimentally measuring N-channel output signals;
deciding an optimum matrix coefficient such that a means squared error between the measured output signal and a desired output signal is minimized in each channel in equation (A); and
executing, by at least one of the first MIMO equalizer and the second MIMO equalizer, equalization processing using the optimum matrix coefficient for at least one of the group of the N-channel first electrical modulated signals and the group of the N-channel second electrical modulated signals, thereby compensating for crosstalk between signals in at least one of the group of the N-channel first electrical modulated signals and the group of the N-channel second electrical modulated signals,
$$\begin{matrix}[ Math . 4 ] & \\ Y = WX & ( A )\end{matrix}$$
where X is a vector of one of the group of the N-channel first electrical modulated signals and the group of the N-channel second electrical modulated signals, Y is a vector of the signals that have undergone the equalization processing, and W is the matrix coefficient W.

8. (canceled)

9. A transmitter configured to, in an optical transmission system sequentially including the transmitter, a communication channel, and a receiver, transmit N-channel analog optical modulated signals to be received by the receiver via the communication channel, characterized by comprising:
a MIMO equalizer to which N-channel digital electrical modulated signals are input;
a DA converter configured to convert the N-channel digital electrical modulated signals into N-channel analog electrical modulated signals;
N RF drivers to which the N-channel analog electrical modulated signals are input; and
N directly-modulated lasers configured to be driven by the N-channel analog electrical modulated signals input to the N RF drivers and output the N-channel analog optical modulated signals,
wherein the MIMO equalizer executes equalization processing using a matrix coefficient based on an impulse response for the N-channel digital electrical modulated signals, thereby compensating for crosstalk between the N-channel electrical modulated signals.

10. (canceled)

11. The optical transmission system according to claim 2, comprising:
a transmitter sequentially comprising
N RF drivers configured to drive the N directly-modulated lasers, and
the N directly-modulated lasers;
a receiver sequentially comprising
the N photodetectors,
N AD converters, and
the MIMO equalizer; and
a communication channel configured to connect the transmitter and the receiver.

12. The optical transmission system according to claim 3, comprising:
a transmitter sequentially comprising
N RF drivers configured to drive the N directly-modulated lasers, and
the N directly-modulated lasers;
a receiver sequentially comprising
the N photodetectors,
N AD converters, and
the MIMO equalizer; and
a communication channel configured to connect the transmitter and the receiver.

13. The optical transmission system according to claim 2, comprising:
a transmitter sequentially comprising
the MIMO equalizer,
N DA converters,
N RF drivers configured to drive the N directly-modulated lasers, and
the N directly-modulated lasers;
a receiver comprising the N photodetectors; and
a communication channel configured to connect the transmitter and the receiver.

14. The optical transmission system according to claim 3, comprising:
a transmitter sequentially comprising
the MIMO equalizer,
N DA converters,
N RF drivers configured to drive the N directly-modulated lasers, and
the N directly-modulated lasers;
a receiver comprising the N photodetectors; and
a communication channel configured to connect the transmitter and the receiver.

15. The optical transmission system according to claim 5, wherein at least one of the transmitter and the receiver is mounted on a PIC.

16. The optical transmission system according to claim 5, wherein at least one of the transmitter and the receiver is mounted on a PIC.
